(19) United States
(12) Patent Application Publication
(10) Pub. No.: US 2007/0026129 A1
(43) Pub. Date: Feb. 1, 2007

(54) High protein aerated food composition

(76) Inventors: Pramod Kumar Pandey, Irwindale, CA (US); Julia Maria Guerrero, Lachine (CA); Margaret Ciaston, Irwindale, CA (US)

Correspondence Address: Ralph A. Dowell of DOWELL & DOWELL P.C., 2111 Eisenhower Ave, Suite 406, Alexandria, VA, 22314, US

(21) Appl. No.: 11/488,819

(22) Filed: Jul. 19, 2006

Related U.S. Application Data
(60) Provisional application No. 60/700,326, filed on Jul. 19, 2005.

(51) Int. Cl. A23J 1/00

(52) U.S. Cl. 426/656

(57) ABSTRACT

The present invention relates to an aerated food composition and a process of making such composition. Particularly, the invention relates to an aerated food composition having a high protein content as well as pleasant organoleptic properties.

### CROSS-REFERENCE TO RELATED APPLICATIONS

The present application claims priority on U.S. provisional application 60/700,326 filed Jul. 19, 2005, the content of which is incorporated in its entirety.

### FIELD OF THE INVENTION

The present invention relates to aerated food composition and process for making such compositions. Particularly, the present invention relates to aerated food compositions having a high protein content, a density and a moisture index such that the compositions have pleasant organoleptic/texture properties.

### BACKGROUND OF THE INVENTION

Aerated compositions, such as marshmallows are known in the art. While there are many types of marshmallows on the market, their methods of preparation generally fall into two main process groups: extruded marshmallow and deposited marshmallow. In both groups, the marshmallow is made up of two main ingredients: a sugar-based syrup and a structuring agent, usually albumin, agar or gelatin. Typically, the sugar-based syrup is heated to reduce its water content and is thereafter cooled down. It is then combined with the structuring agent to form a slurry. The slurry is further aerated to form a foam. Optionally, colors and flavors can be added to the foam. Once the foam is produced, it can be shaped by an extrusion process or a deposition process. In the extrusion process, the foam is extruded through a die to form a rope. The die imparts the desired peripheral shape to the extruded rope. The rope is allowed to rest briefly to set, and then is cut into desired sizes. In the deposition process, the foam is deposited and allowed to rest briefly before shaping. Optionally, the extruded/deposited marshmallows can be dried (refer to U.S. Pat. No. 4,785,551 issued Nov. 2, 1988). Marshmallows may also contain edible coloring and other minor edible ingredients such as edible humectants. However, marshmallows are mostly sugar based confection and the protein content is usually very low.

Dried marshmallows, particularly in smaller or bit sizes, are commonly added to certain popular Ready-To-Eat (“RTE”) breakfast cereals, particularly those marketed to children. Because of the process used for their preparation, proteins and peptides can be added only in limited amounts because they modify the organoleptic properties of the marshmallows. In fact, in the presence of high amounts of proteins can adversely interfere with the desired characteristics of the aerated food composition by negatively affecting the taste, texture and density of the aerated food pieces.

Obesity in North America is mostly due to consumption of unhealthy foods such as product containing high sugar (carbohydrates) foods and beverages. The evolution of nutritional bars in the early nineties gave an alternative choice to health conscious consumers. However, due its inability to meet the consumer expectations of taste and texture, the nutritional bar business is loosing its grounds among its quite large consumer base. Consumers are desperately looking for healthy food/snacks substitutes which must be an healthy choice but, at the same time, have interesting organoleptic properties. Recent medical studies have indicated that a diet containing the recommended daily allowance (RDA) of nutritive ingredients such as proteins, peptides or amino acids, might be effective in preventing physiological diseases and also possibly improving the general health. Proteins and peptides are also of particular nutritional value in growing children to support the growth of different tissues and organs. There is therefore great public interest in the consumption of food products that will supply the recommended daily allowance of such nutritive ingredients.

Patent literature is abundant with respect to the production of aerated compositions. U.S. Pat. No. 2,600,569 issued Jun. 17, 1952, discloses the general process for the production of marshmallows mostly sugar-based as it is known today. U.S. Pat. No. 3,684,528 issued Aug. 15, 1972 discloses the inclusion of very low amount of non-fat dry milk solids (less than 5%) to a marshmallow.

U.S. Pat. No. 4,038,423 issued Jul. 26, 1977, discloses a marshmallow coated with fat and vitamins. The marshmallow described in this patent document may contain an elevated protein content, usually from skim milk powder. In order to avoid that the proteins to harden the marshmallow, the proteins have been denatured by lecithination. Briefly, the proteins have been treated with fats and incorporated in a coating for the marshmallow. Consequently, the protein are included in the coating and are not dispersed in the marshmallow itself. However, such protein treatment may result in the reduction or loss of the biological value of the protein, the reduction or loss of the functional properties of the protein (e.g. such as the film forming ability of the protein) and ultimately, in the modification of the textural properties of the marshmallow (such as a modification in the density of the marshmallow) resulting in the lowering in the number and area of the air pockets in the composition. In addition, lecithination also introduces organoleptic problems and increases the fat content of the marshmallow. Further, lecithination prevents hardening of the marshmallow for a short period of time and eventually, the marshmallow composition hardens due to the presence of the proteins. In the U.S. Pat. No. 4,038,423, a Bloom gelatin is used as a whipping/film forming agent. In addition, the marshmallow described therein is limited to an Oakes-type manufacturing process where air is forced in the marshmallow.

U.S. Pat. No. 6,749,886 issued on Jun. 15, 2004, U.S. Pat. No. 6,432,457 issued on Aug. 13, 2002, 6,299,929 issued on Oct. 9, 2001, relate to confectionery having high a protein content. The confectioneries described therein do not relate to aerated compositions, have a high density and do not possess pleasant organoleptic properties. Considering the state of the art described above, it remains highly desirable to be provided with a new aerated food composition containing high protein content and process of making such composition.

### SUMMARY OF THE INVENTION

The present application relates to aerated food compositions having a high protein content as well as expected texture and organoleptic properties.

In a first aspect of the present invention, there is provided an aerated food composition having a protein content of at least 10% (w/w), a density of between about 0.40 g/cc to about 0.95g/cc and a moisture level of between about 10% to about 30%. In an embodiment, the protein content is between about 15% to about 35% (w/w). In another embodiment, the density is between about 0.4 g/cc to about 0.9 g/cc and, in a further embodiment, between about 0.5 g/cc to about 0.75 g/cc. In a further embodiment, the moisture level is between about 12% to about 22%. In yet another embodiment, the protein is derived from a whey protein isolate. In still another embodiment, the protein is an hydrolyzed protein. In yet a further embodiment, the protein prevents hardening of the aerated food composition. In still another embodiment, the aerated food composition further comprise a whipping agent. The whipping agent may be selected from the group consisting of egg albumen, egg white, vegetable protein, soy-derived protein, milk-derived compound, milk protein, modified milk protein, casein, caseinate, whey protein, pea protein and wheat gluten. In yet another aspect, the aerated food composition further comprises fat. In an embodiment, the fat content of the composition is less than about 5% (w/w) and, in a further embodiment, the fat content is less than about 2% (w/w). In yet another embodiment, the fat is selected from the group consisting of fractionated fat, partially fractionated fat, hydrogenated oil, partially hydrogenated oil, unsaturated oil, coconut oil, palm oil, paln kernel oil, cottonseed oil, safflower oil, sunflower oil, soy oil, corn oil, monoglyceride and lecithin. In still a further embodiment, the aerated composition further comprises an emulsifier. In still another embodiment, the emulsifier is selected from the group consisting of an ester of polyglycerol, lactylate of sodium, lactylate of potassium, lactylate of calcium, lactate of sodium, lactate of potassium and lactacte of calcium. In yet a further embodiment, the aerated composition further comprises a stabilizer. The stabilizer may be selected from the group consisting of a hydrocolloid, a gelatin and a gum. In an embodiment, the stabilizer is at least one of exudate, arabic gum, tragacanth, karaya, ghatti, seaweed extract agar, alginate, carrageenan furcellaran, plant seed gum, guar gum, locust bean, psyllium, quince, tamarind, non-fermentable cereal gum, corn hull gum, plant extract, arabinogalactan, fermentation gum, dextran, xanthan and curdlan. In still a further embodiment, the aerated food composition further comprises a carbohydrate. In an embodiment, the carbohydrate of the aerated composition is between about 37% and 75% (w/w). In yet another embodiment, the carbohydrate is selected from the group consisting of a monosaccharide (such as glucose, fructose and/or galactose), a disaccharide (such as sucrose, lactose and/or maltose), a non-starch polysaccharide (such as cellulose, pectin, gum, beta-glucan and/or fructan), a sugar alcohol (such as sorbitol, mannitol, xylitol, erythritol, maltitol, lactitol and glycerol), an oligosaccharide (such as raffinose, stachyose, verbascose and/or fructooligosaccharide) and a polysaccharide (such as starch, dextrin, inulin and/or polydextrose). In yet a further embodiment, the aerated food composition further comprises a flavoring agent.

### DETAILED DESCRIPTION OF THE PREFERRED EMBODIMENT

The present application relates to aerated compositions comprising a high protein content. The ingredients of the aerated composition must be food-grade products since the composition is mainly designed for human consumption.

As used herein, the term “aerated composition” refers to a composition having air or gas pockets surrounded by a matrix. The matrix mainly contains carbohydrates and proteins and, optionally, fat. In an embodiment, the air or gas pockets in the aerated composition are distributed heterogeneously in the composition. In a further embodiment, the air or gas pockets in the aerated composition occupy a smaller volume than the matrix. In another embodiment, the air or gas pockets in the aerated composition occupy a volume substantially similar to the matrix. In yet another embodiment, the air pockets occupy a bigger volume than the matrix.

The aerated composition described herein comprises a high protein content. As used herein, the term “protein” is intended to refer to a compound having an amino acid subunit. The amino acid subunit can be linked by a peptidic bond to another amino acid or to another compound. The term protein thus includes amino acids, small peptides as well as polypeptides. The proteins can be from vegetable, animal or synthetic origin. In an embodiment, the proteins of the aerated composition are not from skim milk powder, but are hydrolyzed or non-modified protein isolate derived from milk or from a vegetable source. They can be native proteins or processed proteins (hydrolyzed, lyophilized, modified, addition or removal of an entity such as a glucose group, coupling to another entity, etc.). When the proteins used are modified, they still retain their biological properties, such as their film-forming properties. In an embodiment, the proteins can be hydrolyzed to a specific degree. When hydrolyzed proteins are used, they are able to control the water binding of the aerated composition in order to prevent or delay the hardening of the composition. In a further embodiment, the proteins used in the composition are not denatured. In yet another embodiment, when the aerated composition is coated, the proteins used in the composition are present in the aerated composition itself but are essentially absent from the coating. In yet another embodiment, the proteins present in the composition are not treated with fat (e.g. are not submitted to lecithination).

As used herein, the term “high protein content” refers to a protein content in the aerated composition of at least 10%. In an embodiment, the protein content of the aerated composition is between about 10% and 45% and, in a further embodiment, between 15% to about 35%. Protein content may be quantified in food compositions by methods known to those skilled in the art. The method for achieving these results may either be indirect or direct methods. These methods include, but are not limited to, the determination of total nitrogen content, ion-exchange, gas-liquid or high-performance liquid chromatography. Another method includes determining the proteins content of the aerated compositions by calculating the proteins content of the food material used to produce the compositions. These methods usually generate a percentage of proteins with respect to the total compositions (w/w).

The proteins used in the compositions preferably have a reduced water binding ability. Proteins with high water binding capacity tend to harden the aerated composition. Usually, when proteins are added to an aerated composition, they tend to attract and/or retain water. The water binding ability thus favors the movement of the protein and of components of the matrix of the composition and, eventually the filing of the air pockets (e.g. lowering of the number of air pockets and/or of the area occupied by the air pockets) of the composition, thereby causing the hardening of the composition. Therefore, the proteins usually tend to augment the density of the aerated composition. Suitable proteins that can be used in the aerated composition described herein can be, for example, non-hydrolyzed proteins such as whey protein isolate or concentrate, caseinates, acid casein, milk protein concentrate or isolate, soy protein isolate, hydrolyzed proteins (such as hydrolyzed whey protein, hydrolyzed gelatin, hydrolyzed soy protein isolate, hydrolyzed milk protein isolate, hydrolyzed caseinates and/or hydrolyzed vegetable protein isolate), peptides or amino acids. One advantage of using an hydrolyzed protein is that the hydrolysis reduces substantially the water holding or binding ability of proteins. Several proteins are commercially available or may be hydrolyzed to a predetermined degree. Such proteins are, for example, soy protein, whey protein, milk protein, caseinates, vegetable proteins and egg albumin.

The aerated composition described herein has a density between about 0.40 g/cc and about 0.95 g/cc, depending on the method of producing the composition. In an embodiment, the density of the composition is between about 0.4 g/cc to about 0.9 g/cc and, in a further embodiment, the density is between about 0.5 to about 0.75 g/cc. As used herein, the terms “density” and “specific gravity” are used herein interchangeably and refer the ratio of the weight of the composition to that of an equal volume of water at t′° and t°. Unless otherwise specified, the specific gravity (d) means the ratio of the weight of the sample to that of an equal volume of water at 20°. The density of a composition is thus defined as the ratio of the density of the substance to the density of water (1 gram/cm³ or g/cc). This ratio is a convenient physical property since it has no units and is therefore independent of the system of measure we may use to determine it. The density may be determined by using an instrument such as a pycnometer, Mohr-Westphal Balance, hydrometer, Sprengel-Ostwald pycnometer and/or density/specific gravity meter. The density can also be determined by using the density by buoyancy force principle using Archimedes' principle. Archimedes' principle states that the buoyant force experienced by a submerged object is equal to the weight of the liquid displaced by the object. Experimentally this appears in the fact that the submerged object apparently weighs less by an amount equal to the weight of the liquid displaced. The buoyant force (F_{b}) can be expressed as:
F_{b}=Wₐᵢᵣ−W_{liquid}=dgv
where d is the density of the liquid, g is the acceleration of gravity and v is the volume of the immersed object (or the immersed part of the body if it floats). The specific gravity or density can be calculated by weighing the aerated composition sample in air then obtaining the volume it displaces by applying force against buoyant force just enough to submerge the solid completely. The density of the composition may be modified by altering the ingredients of the composition and/or adjusting the processing conditions. Aerating gases such as carbon dioxide, nitrogen and air can be used to modulate the density of the composition.

The aerated composition described herein possess a moisture level between about 10% to about 30%. As used herein, the term “moisture level” refers to the percentage of water in a composition (w/w). Methods and instruments for evaluating the moisture level of foods are known to those skilled in the art. Such methods include, but are not limited to, evaporation methods, distillation methods, chemical reaction methods (such as the Karl-Fisher titration and the gas production method), physical methods and spectrometric methods (such as X-rays, UV-visible, NMR, microwaves and IR). The moisture content in the aerated composition can be also calculated during formulation by knowing and adding the moisture of each ingredients.

The aerated composition can also comprise a whipping agent. Such agents are conventionally used in small amounts; typically between about 0.01% to about 20.0% by weight. Optionally, the whipping agent can also include proteins, such as egg albumen, egg white, vegetable proteins, soy-derived protein, milk-derived compound, milk protein, modified milk protein, casein, caseinate, whey protein, pea protein and/or wheat gluten. In an embodiment, the whipping agent is egg white or VERSA WHIP™ (a soy-based whipping agent).

The aerated food composition may also comprise fat and may preferably have a low fat content. In an embodiment, the aerated composition, without a coat, comprises less than 5% and preferably less than 2% of fat (w/w). In another embodiment, when the composition comprises a coating, its fat content is higher than 2%, preferably higher than 5%. Examples of fat that can be used in the composition are fractionated fat, partially fractionated fat, hydrogenated oil, partially hydrogenated oil, unsaturated oil, coconut oil, palm oil, palm kernel oil, cottonseed oil, safflower oil, sunflower oil, soy oil, corn oil, monoglyceride and/or lecithin.

The aerated food composition may also comprise an emulsifier, e.g. a surface-active agent promoting the formation and stabilization of the emulsion. Such emulsifiers include, but are not limited to, an ester of polyglycerol, lactylate of sodium, lactylate of potassium, lactylate of calcium, lactate of sodium, lactate of potassium and/or lactacte of calcium. The addition of small amount of fat (less than 5% or less than 2%) and an emulsifier can facilitate the processing of the aerated composition by helping handling and shaping the aerated composition. The addition of ester of polyglycerol, lactylate of sodium, lactylate of potassium, lactylate of calcium, lactate of sodium, lactate of potassium and/or lactacte of calcium can also act as humectants to protect the air pockets of the aerated composition and hence provide appropriate density/texture to the composition.

The aerated food composition may also comprise a stabilizer/thickening agent to achieve the desired organoleptic properties. Such stabilizer/thickening agent may be an hydrocolloid, a gelatin and/or a gum. Examples of such stabilizer/thickening agent include, but are not limited to, exudate, arabic gum, tragacanth, karaya, ghatti, seaweed extract agar, alginate, carrageenans furcellaran, plant seed gum, guar gum, locust bean, psyllium, quince, tamarind, non-fermentable cereal gum, corn hull gum, plant extract, arabinogalactan, fermentation gum, dextran, xanthan and curdlan.

The aerated food composition may also comprise carbohydrates. The present aerated compositions may comprise from about 37% to about 75% (w/w), of a carbohydrate. In an embodiment, the ratio of proteins to carbohydrates in the composition is less than one. The carbohydrates may be, for example monosaccharide (e.g. a single sugar molecule, such as glucose, fructose or galactose), a disaccharide (e.g. a sugar having two saccharide subunits, such as sucrose, lactose or maltose), a non-starch polysaccharide (e.g. a fibre, such as cellulose, pectin, gum, beta-glucan or fructan), a sugar alcohol (e.g. polyol such as sorbitol, mannitol, xylitol, erythritol, maltitol, lactitol or glycerol), an oligosaccharide (e.g. a chain of three to ten monosacharride units, such as raffinose, stachyose, verbascose or fructooligosaccharide) and a polysaccharide (e.g. a chain of more than ten monosacharride units, such as starch, dextrin, inulin or polydextrose).

The marshmallow syrup (or marshmallow liquid mix) is the mixture of ingredients that is aerated and whipped to form marshmallow. The marshmallow syrup may contain ingredients such as fructose, high fructose corn syrup , corn syrup, honey, sucrose, sorbitol (liquid or powder), maltitol, isomalt, oligofructose (hydrolyzed inuline), fructooligosachride (FOS), inuline, glycerine, cane juice concentrate, fruit juice concentrate, etc. Depending on the method for marshmallow production, marshmallow syrup usually has a moisture content of about 10 to 30% by weight, very little of which is lost in processing.

The aerated composition can also comprise flavoring agents known to modify the taste of marshmallow. These flavoring agents can enhance the taste properties of the aerated composition particularly in compositions having a low fat (e.g. less than 1% percent by weight fat). Marshmallow having a low fat content usually do not show fat being precluded during whipping and aeration. Some attempts have been made to increase the oil or fat content in marshmallow, generally by the addition of certain additives which prevent the oil from breaking the emulsion or whip. While these attempts have met minor success in providing incremental increases in fat content, the additional additives have created an off-taste or foreign taste which has made the marshmallow product unacceptable.

The aerated compositions produced are preferably very palatable soft texture and have good organoleptic properties. The aerated compositions described herein can also be shaped easily in various forms. In an embodiment, the aerated product can be shaped in a nougat-typed product and/or a marshmallow-type product. The aerated compositions can also be coated (enrobed) or not or filled in various containers. The aerated composition can also be included in a layer in a nutritional bar (coated or uncoated).

The present invention also provides a process for preparing the aerated composition described herein. The matrix of these confections may make use of a crystallized or not crystallized sugar in order to achieve desired textural properties for the confections.

The process for making such compositions first comprises preparing a liquid blend. Such liquid blend comprises water or an aqueous solution (such as milk or juices), as well as carbohydrates (in powder or liquid form). Optionally, the liquid blend may also comprise a stabilizer, a pre-hydrated hydrocolloid, flavors and/or colors. The ingredients of the liquid blend are mixed until they are dissolved. The liquid blend is then added to (e.g. dropped on) a powder blend, mixed and whipped to form the aeration composition. The powder blend usually comprises proteins and, optionally, carbohydrates, flavors and/or colors. In an embodiment, the liquid blend is heated at a temperature between about 60° C. to 105° C. (e.g. 75° C. to 85° C.) prior to their incorporation in the powder blend. Optionally, an emulsifier can be added to the powder blend, before, simultaneously or after adding the liquid blend. In an embodiment, the powder blend is mixed with a dough mixer, such as a double arm sigma type high speed dough mixer. In a further embodiment, the powder blend is mixed for a time period of one minute before being added to the liquid blend. In a further embodiment, the mixing of the liquid blend with the powder blend lasts between 15 to 45 seconds. Optionally, the first mixing of the liquid blend can be followed by a second mixing lasting between 15 to 45 seconds at a higher pace (e.g. about two times higher than the first mixing). The second mixing period can be followed by a third mixing period of between 1 to 5 minutes, at a higher mixing speed (e.g. about three times higher than the first mixing). In an embodiment, the first mixing lasts between 25 to 35 seconds at a speed of between 25 to 35 RPM, the second mixing lasts between 25 to 35 seconds at a speed of between 55 to 65 RPM, and the third mixing lasts between 2 to 4 minutes at a speed of between 85 to 105 RPM.

One advantage of the process described herein is that there is no need to inject air or a gas in the composition to produce an aerated composition having the appropriate texture properties. Therefore, the aerated composition can be produced at normal atmospheric pressure. In an embodiment, the process can be modified to include the injection of air or gas in the composition.

The aerated food compositions obtained by this process can further be converted to desired shape (typically bar). The aerated food compositions, or masse (dough) can be extruded or slabbed, slit and guillotined to desired size before coated with confectionery coating and finally wrapped. They can also be put in between two layers as sandwich and further processed.

Once in final form, the aerated composition can be enrobed with confectionery coating specially design to protect soft center of the aerated composition or can be placed in an air-sealed wrapping or container.

The present invention will be more readily understood by referring to the following examples which are given to illustrate the invention rather than to limit its scope.

### EXAMPLE I

General Process for the Preparation of Aerated Compositions.

Preparation of the liquid blend. The liquid blend contains all liquid ingredients as well as the sugar powdered ingredients (such as sucrose, fructose, sorbitol, dextrose, fructo-oligosaccharide and/or inuline). Optionally, it can also comprise hydrocolloids, gelatine, liquid flavors and/or liquid colors. The liquids are weighed and added into a high shear liquid mixer. The crystalline materials (such as sugar, sorbitol, fructose, dextrose and/or powdered inuline-hydrolyzed or non hydrolyzed) are then added to the mixer. The liquids and the powder/crystal ingredients are mixed in a high shear jacketed liquefier. The surface of the liquefier may be heated or cooled. The liquid and powdered/crystal ingredients are mixed until the temperature of mixture reaches approximately between 75° C. to 85° C. or until all powdered/crystal ingredients are dissolved. Once the powdered/crystal ingredients are dissolved, the pre-hydrated gelatin or hydrocolloids can be added and shear mixed until they dissolved in liquid mixture. Lactates or lactylates of sodium, potassium or calcium may be also added at this stage or later during the whipping stage. Finally, the liquid flavors and/or colors can be added to the mixture and mixed for a few seconds. The final liquid blend is then transferred into a holding tank which is also jacketed and attached to same heating medium as high speed mixer/liquefier.

Preparation of the powdered blend All powdered ingredients are accurately weighed as per the recipe and transferred into the double arm sigma type high speed dough mixer. The powder ingredients can be mixed for 1 minute at 60 RPM.

Preparation of the dough mixture. The liquid blend is dropped into the dough mixer containing the powdered blend from the liquid holding tank. After the liquid droping is completed, the dough mixer is programmed to perform the following mixing steps: i) 30 rpm for 30 seconds; ii) 60 rpm for 30 seconds, and iii) 90-100 rpm for 2-4 minutes. During these mixing stages, the minerals, vitamins and foam stabilizers may be added.

Preparation of the aerated composition. The aerated dough is then taken out from the high speed dough mixer either on a conveyer belt directly or on a dough table in bins to feed the bar manufacturing line. The aerated dough is then further slabbed, slit, guillotined, coated and/or wrapped like any confectionery bars.

### EXAMPLE II

Vanilla Marshmallow Fructose and Sorbitol Composition

Table 1 lists the quantity of ingredients used to prepare the composition.

The ingredients of the liquid blend were mixed and heated between 75° C. to 85° C. The liquid blend was than transferred to a heated holding tank. The temperature of the liquid mixture in the holding tank was maintained between 75° C. to 85° C. The ingredients of the powder blend #1 and #2 were independently mixed and then combined. The heated liquid mixture was dropped on top of the powder blend. The mixture is then left to settle for a couple of minutes. Finally the fats were pre-melted and added to the mixture. The final mixture was jogged before the aerated composition was removed from the mixer for processing (e.g. shapped). The aerated composition can be further slabbed and shaped or it can then be layered on top of a more rigid structure core dough or sandwiched between two more rigid structures core dough.

Per serving of 100 g, this composition has 316.4 Cal, 32.5 g of proteins, 50.0 g of carbohydrates, 2.1 g of dietary fibers, 19.4 g of total sugar, 1.7 g of fat and 12.1 g of water. The density of the composition is between 0.5 to 0.65 g/cc.

TABLE 1
Quantity (in kg) of the ingredients used in the preparation
of the composition.

| | |
|---|---|
| Ingredients | kg |

Bottom layer

| | |
|---|---|
| Vitamin blend | 3.19 |
| Dicalcium Phosphate | 5.97 |
| Magnesium oxide | 3.98 |

Powder blend #1

| | |
|---|---|
| Whey protein isolate (Provon) | 100.00 |
| Whey protein isolate (Thermax) | 50.00 |
| Caseinate calcium (Miprodan) | 40.00 |
| Whey protein isolate (ProtArmor) | 35.00 |
| Dried egg albumen | 30.00 |
| Gelatin | 30.00 |
| Corn dextrin | 20.00 |
| Tartaric acid | 1.30 |
| Cinnamon brown color | 3.00 |
| Caramel flavor | 5.00 |
| Vanilla creamy flavor | 3.00 |
| Natural and artificial cream flavor | 3.00 |

Powder blend #2

| | |
|---|---|
| Powdered sucralose (Splenda ™) | 0.05 |
| Water | 0.15 |

Liquid blend

| | |
|---|---|
| High fructose corn syrup | 194.5 |
| Crystalline sorbitol powder | 168.90 |
| Glycerine | 33.60 |
| Water | 26.00 |
| Potassium Lactate (Purasal) | 5.30 |

Fats

| | |
|---|---|
| Monoglycerides (PANALITE) | 4.00 |
| Modified Palm Kernel Oil | 7.00 |
| Total weight | 773 |

### EXAMPLE III

Aerated Composition with a Caramel Layer and Having a Coffee Almond Flavor Without Any Egg Ingredient as a Whipping Agent

TABLE 2
Quantity (in percentage of final weight) of the ingredients
used in the preparation of the composition.

| | |
|---|---|
| Ingredients | % |

Powder blend

| | |
|---|---|
| Whipping agent (VERSAWHIP ™) | 1.92% |
| Soy protein isolate | 0.66% |
| Whey protein isolate (Alacen) | 4.72% |
| Caseinate calcium | 2.83% |
| Whey protein isolate (Thermax) | 2.13% |
| Tartaric acid | 0.06% |
| Corn dextrin | 0.43% |
| Vanilla creamy flavor | 0.23% |
| Salt | 0.06% |
| Chocolate flavor | 0.13% |
| Instant coffee | 0.03% |
| Glycerine | 1.36% |

Liquid blend

| | |
|---|---|
| Sorbitol solution 70% | 4.60% |
| Evaporated cane juice syrup certified organic | 2.70% |
| Potassium lactate | 0.26% |
| Crystalline maltitol | 4.85% |
| Crystalline fructose | 4.05% |
| Sugar | 4.05% |
| Beet extract | 0.03% |
| Caramel color powder | 0.22% |
| Black cocoa powder | 0.02% |

Pectin solution

| | |
|---|---|
| Water | 2.37% |
| Crystalline fructose | 1.19% |
| Pectin | 0.43% |

Flavors

| | |
|---|---|
| Debitter | 0.36% |
| Chocolate semi-sweet | 0.48% |

Fats

| | |
|---|---|
| Monoglycerides | 0.19% |
| Modified Palm Kernel Oil | 0.34% |

Caramel bottom layer

| | |
|---|---|
| Vitamin blend | 0.85% |
| Encapsulated magnesium oxide 40% | 0.31% |
| Tricalcium phosphate | 0.55% |
| Caramel sugar | 16.66% |

Topping

| | |
|---|---|
| Almonds, roasted, diced large | 6.32% |

Coating

| | |
|---|---|
| CLASENCoat milk chocolate | 34.58% |

Table 2 lists the quantity of ingredients used to prepare the composition. The ingredients of the powder blend were mixed. The ingredients of the liquid blend are mixed, heated to 105° C. and then cooled down to 60° C. before their addition to the powder blend. A pectin solution is prepared by pre-blending the fructose and pectin and adding the pre-blend to heated water (80° C.-90° C.) while mixing at high speed. The liquid blend and the pectin solution are added simultaneously to the powder blend. The blend is then mixed to allow the hydration of the powder blend ingredients. The blend is further whipped for several minutes. The flavors are then added to the blend. The blend is further whipped for one minute. The blend is left to settle for five minutes. The fats, pre-melted at a temperature of 40° C., are then added to the blend to produce the aerated composition. The aerated composition is then placed on top of a caramel bottom layer. It is further sprinkled with almonds and enrobed in a chocolate coating.

Per serving of 100 g, this composition has 419.5 Cal, 20.9 g of proteins, 50.7 g of carbohydrates, 2.3 g of dietary fibers, 34.9 g of total sugar, 16.3 g of fat and 8.8 g of water. Because the composition of this example is coated with caramel, the total fat is higher than 2% (w/w) and the moisture is lower than 10%. The aerated composition of this example, without a caramel layer has a fat content of less than 2% and a moisture content higher than 10%. The density of the composition is between 0.55 to 0.75 g/cc.

### EXAMPLE IV

Almond Chocolate Aerated Composition

Table 3 lists the quantity of ingredients used to prepare the composition. The ingredients of the powder blend #1 are mixed together. The ingredients of the powder blend #2 are mixed together. The ingredients of the liquid blend #1 are mixed in a high speed mixer and heated at 75° C. The fructooligosaccharide (FOS) is then hydrated in water. The hydrated FOS and the ingredients of the liquid blend #2 are added to the liquid blend #1 to produce the liquid blend. The liquid blend is then added to the powder blend #1. The blend is mixed to hydrate the powdered ingredients. The blend is then whipped for several minutes. The powder blend #2 and the almond flavor are then added to the blend. The blend is whipped for one minute. The blend is left to settle for a couple of minutes and then the fats are added.

Per serving of 100 g, this composition has 342.2 Cal, 31.5 g of proteins, 50.0 g of carbohydrates, 10 g of dietary fibers, 28.1 g of total sugar, 2.1 g of fat and 13.2 g of water. The density of the composition is between 0.50 to 0.65 g/cc.

TABLE 3
Quantity (in percentage of final weight) of the ingredients
used in the preparation of the composition.

| | |
|---|---|
| Ingredients | % |

Powder blend #1

| | |
|---|---|
| Whey protein isolate (Provon) | 10.71% |
| Whey protein isolate (Thermax) | 5.41% |
| Caseinate calcium | 5.92% |
| Whey protein isolate (ProtArmor) | 5.41% |
| Dried egg albumen | 4.08% |
| Gelatin | 3.88% |
| Corn dextrin | 2.48% |
| Crystallinesorbitol powder | 1.93% |
| Salt | 0.41% |
| Chocolate flavor | 0.88% |
| Instant coffee gold cup | 0.20% |
| Tartaric acid | 0.12% |
| Ethyl vanillin flavor | 0.05% |

Powder blend #2

| | |
|---|---|
| Vitamin blend | 0.61% |
| Encapsultated magnesium Oxide 40% | 0.47% |

Liquid blend #1

| | |
|---|---|
| Water | 1.50% |
| Alginate blend | 0.19% |
| Crystalline fructose | 0.25% |

FOS

| | |
|---|---|
| Water | 7.70% |
| Fructooligosaccharide powder | 8.62% |

Liquid blend #2

| | |
|---|---|
| Crystalline fructose | 27.05% |
| Glycerine | 7.36% |
| Potassium lactate | 1.70% |
| Cocoa extract flavor | 1.10% |
| Debitter | 0.41% |
| Caramel color powdered | 0.10% |
| Lake blend chocolate color | 0.02% |

Fats

| | |
|---|---|
| Monoglycerides | 0.67% |
| Modified Palm Kernel Oil | 0.77% |

### EXAMPLE V

Chocolate Marshmallow Composition

Table 4 lists the quantity of ingredients used to prepare the chocolate marshmallow composition.

The ingredients of the powder blend are mixed together. The ingredients of the liquid blend #1 are mixed and heated to 80° C. The ingredients of the liquid blend #2 are mixed and are added to the liquid blend #1 to produce the liquid mixture. The liquid blend is dropped on the powder blend, mixed and whipped 30 RPM for 30 seconds, 60 RPM for 30 seconds and 90-100 rpm for 2 to 4 minutes. During these mixing stages the minerals, vitamins and foam stabilizers (optional-either with liquid or powdered at this stage) may be added. The blend is left to settle for a couple of minutes. Melted fats are then added to the mixture to form the final aerated composition.

Per serving of 100 g, this composition has 350.0 Cal, 30.3 g of proteins, 54.1 g of carbohydrates, 2.7 g of dietary fibers, 42.2 g of total sugar, 1.4 g of fat and 12.2 g of water. The density of the composition is between 0.55 to 0.75 g/cc.

TABLE 4
Quantity (in percentage of final weight) of the ingredients used
in the preparation of chocolate marshmallow composition.

| | |
|---|---|
| Ingredients | % |

Powder mixture

| | |
|---|---|
| Whey protein isolate (Provon) | 10.92 |
| Caseinate | 7.92 |
| Whey protein isolate (Thermax) | 6.25 |
| Whey protein isolate (ProtArmor) | 6.04 |
| Dried egg albumen | 3.38 |
| Corn dextrin | 3.28 |
| Chocolate flavor | 2.82 |
| Nat Protein Masking | 0.96 |
| Tartaric acid | 0.12 |
| Vanillin flavor | 0.10 |

Liquid mixture #1

| | |
|---|---|
| High fructose corn syrup invertose | 25.95 |
| Crystalline fructose | 21.81 |
| Water | 2.28 |
| Glycerine | 4.63 |
| Potassium lactate | 0.69 |
| Caramel color powdered | 0.16 |
| Lake blend chocolate color | 0.03 |

Liquid mixture #2

| | |
|---|---|
| Water | 1.17 |
| Alginate blend | 0.12 |
| Crystalline fructose | 0.23 |

Fats

| | |
|---|---|
| Modified Palm Kernel Oil | 0.71 |
| Monoglycerides | 0.41 |

While the invention has been described in connection with specific embodiments thereof, it will be understood that it is capable of further modifications and this application is intended to cover any variations, uses or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. An aerated food composition having a protein content of at least 10% (w/w), a density of between about 0.40 g/cc to about 0.95g/cc and a moisture level of between about 10% to about 30%.

2. The aerated food composition of claim 1, wherein the density is between about 0.4 g/cc to about 0.9 g/cc.

3. The aerated food composition of claim 1, wherein the density is between about 0.5 g/cc to about 0.75 g/cc.

4. The aerated food composition of claim 1, wherein the moisture level is between about 12% to about 22%.

5. The aerated food composition of claim 1, wherein the protein content is between about 15% to about 35%(w/w).

6. The aerated food composition of claim 1, wherein the protein is derived from a whey protein isolate.

7. The aerated food composition of claim 1, wherein the protein is an hydrolyzed protein.

8. The aerated food composition of claim 1, wherein the protein prevents hardening of the aerated food composition.

9. The aerated food composition of claim 1, further comprising a whipping agent.

10. The aerated food composition of claim 9, wherein the whipping agent is selected from the group consisting of egg albumen, egg white, vegetable protein, soy-derived protein, milk-derived compound, milk protein, modified milk protein, casein, caseinate, whey protein, pea protein and wheat gluten.

11. The aerated food composition of claim 1, further comprising fat.

12. The aerated food composition of claim 11, wherein the fat content is less than about 5% (w/w).

13. The aerated food composition of claim 11, wherein the fat content is less than about 2% (w/w).

14. The aerated food composition of claim 11, wherein the fat is selected from the group consisting of fractionated fat, partially fractionated fat, hydrogenated oil, partially hydrogenated oil, unsaturated oil, coconut oil, palm oil, palm kernel oil, cottonseed oil, safflower oil, sunflower oil, soy oil, corn oil, monoglyceride and lecithin.

15. The aerated food composition of claim 1, further comprising an emulsifier.

16. The aerated food composition of claim 15, wherein the emulsifier is selected from the group consisting of an ester of polyglycerol, lactylate of sodium, lactylate of potassium, lactylate of calcium, lactate of sodium, lactate of potassium and lactacte of calcium.

17. The aerated food composition of claim 1, further comprising a stabilizer.

18. The aerated food composition of claim 17, wherein the stabilizer is selected from the group consisting of a hydrocolloid, a gelatin and a gum.

19. The aerated food composition of claim 17, wherein the stabilizer is selected from the group consisting of exudate, arabic gum, tragacanth, karaya, ghatti, seaweed extract agar, alginate, carrageenan furcellaran, plant seed gum, guar gum, locust bean, psyllium, quince, tamarind, non-fermentable cereal gum, corn hull gum, plant extract, arabinogalactan, fermentation gum, dextran, xanthan and curdlan.

20. The aerated food composition of claim 1, further comprising a carbohydrate.

21. The aerated food composition of claim 20, wherein the carbohydrate content is between about 37% to about 75% (w/w).

22. The aerated food composition of claim 20, wherein the carbohydrate is selected from the group consisting of a monosaccharide, a disaccharide, a non-starch polysaccharide, a sugar alcohol, an oligosaccharide and a polysaccharide.

23. The aerated food composition of claim 22, wherein the monosaccharide is selected from the group consisting of glucose, fructose and galactose.

24. The aerated food composition of claim 22, wherein the disaccharide is selected from the group consisting of sucrose, lactose and maltose.

25. The aerated food composition of claim 22, wherein the non-starch polysaccharide is selected from the group consisting of cellulose, pectin, gum, beta-glucan and fructan.

26. The aerated food composition of claim 22, wherein the sugar alcohol is selected from the group consisting of sorbitol, mannitol, xylitol, erythritol, maltitol, lactitol and glycerol.

27. The aerated food composition of claim 22, wherein the oligosaccharide is selected from the group consisting of raffinose, stachyose, verbascose and fructooligosaccharide.

28. The aerated food composition of claim 22, wherein the polysaccharide is selected from the group consisting of starch, dextrin, inulin and polydextrose.

29. The aerated food composition of claim 1, further comprising a flavoring agent.
